(19) United States
(12) Patent Application Publication
(10) Pub. No.: US 2025/0281349 A1
(43) Pub. Date: Sep. 11, 2025

(54) WEARABLE DEVICE FOR VIBRATORY STIMULATION AND METHODS OF USE

(71) Applicant: Encora, Inc., Boston, MA (US)

(72) Inventors: Daniel Carballo, Boston, MA (US); Kristopher Vu, Malden, MA (US); Kyle Pina, Somerville, MA (US)

(21) Appl. No.: 19/075,377

(22) Filed: Mar. 10, 2025

Related U.S. Application Data
(60) Provisional application No. 63/563,646, filed on Mar. 11, 2024.
(60) Provisional application No. 63/703,661, filed on Oct. 4, 2024.

(51) Int. Cl. A61H 23/02; A61H 1/00

(52) U.S. Cl. CPC A61H 23/02; A61H 1/00; A61H 2201/1638

(57) ABSTRACT

In an embodiment, a method of reducing movement disorder symptom severity of a patient is presented. A method may include securing a wearable device to a body part of a patient through an attachment system. A method may include activating a mechanical transducer of a wearable device to provide a vibratory output to one or more nerves in a vicinity of a wrist of the patient. A vibratory output may have a vibrational strength of about 0.30 Gᵣₘₛ to about 0.78 Gᵣₘₛ.

### CROSS-REFERENCE TO RELATED APPLICATIONS

This application claims priority to, and the benefit of, U.S. Prov. App. No. 63/703,661, filed Oct. 4, 2024, and U.S. Prov. App. No. 63/563,646, filed Mar. 11, 2024, each of which is incorporated by reference herein in their entirety.

### SUMMARY

In an embodiment, a method of reducing movement disorder symptom severity of a patient is presented. A method may include securing a wearable device to a body part of a patient through an attachment system. A method may include activating a mechanical transducer of a wearable device to provide a vibratory output to one or more nerves in a vicinity of a wrist of the patient. A vibratory output may have a vibrational strength of about 0.30 Gᵣₘₛ to about 0.78 Gᵣₘₛ.

In an embodiment, a wearable device for mitigating movement disorder symptoms is presented. A wearable device may include an attachment system configured to secure the wearable device to a body part of a patient. A wearable device may include a single mechanical transducer. A wearable device may include a processor in communication with a single mechanical transducers. A processor may be configured to activate a single mechanical transducer to provide a vibratory output to one or more nerves in a vicinity of a wrist of a patient. A vibratory output may have a vibrational strength of about 0.30 Gᵣₘₛ to about 0.78 Gᵣₘₛ.

### BRIEF DESCRIPTION OF THE DRAWINGS

The subject matter of the present disclosure will be explained in more detail in the following text with reference to preferred exemplary and non-limiting embodiments which are illustrated in the attached drawings.

FIG. 1 is an illustration of a wearable device in accordance with embodiments described herein.

FIG. 2 shows the flexor muscles and tendons of the wrist, fingers, and thumb.

FIG. 3 shows the extensor muscles and tendons of the wrist, fingers, and thumb.

FIG. 4 depicts the somatosensory afferents targeted, which are the subset of cutaneous mechanoreceptors.

FIG. 5 shows the locations of the upper limb dermatomes innervated by the C5, C6, C7, C8, and T1 spinal nerves.

FIG. 6 is an exploded isometric view of a wearable device, in which the transducers are housed in the band rather than in the main electronics housing, in accordance with an embodiment described herein.

FIG. 7 is a box and whisker plot showing the immediate improvement from baseline in hand tremor rating in 8 Essential Tremor patients subject to stimulation of varying intensities, in accordance with an embodiment described herein.

FIG. 8 is a box and whisker plot showing the immediate improvement from baseline in hand tremor rating in 3 Essential Tremor and 3 Parkinson's tremor patients subject to stimulation of varying anatomic targets, in accordance with an embodiment described herein.

FIG. 9 illustrates test results showing acute and cumulative improvements with frequency matched, phase rest, and inactive stimulation using BF-ADL Scoring.

FIG. 10 illustrates test results showing acute and cumulative improvements with frequency matched, phase rest, and inactive stimulation in subjects using TETRAS Spiral Scoring.

FIG. 11 illustrates a total BF-ADL score responder analysis between acute improvement and cumulative improvement in subjects.

FIG. 12 illustrates a TETRAS spiral responder analysis of both acute and cumulative improvements of subjects

FIG. 13 illustrates test results of perceived stimulation in subjects.

FIG. 14 illustrates a comparison of perceived stimulation to improvement in movement disorder systems in subjects.

FIG. 15 illustrates a method of reducing movement disorder symptom severity in a patient.

These figures disclose embodiments of the present disclosure for illustrational purposes only. In particular, the disclosure provided by the figures and description is not meant to limit the scope of protection conferred by the present disclosure.

### DETAILED DESCRIPTION

Aspects of the present disclosure can be used to provide a reduction in movement disorder symptoms through a wearable medical device. In an embodiment, a wearable medical device may provide vibratory stimulus to a body part of a patient. A vibratory output may be below a sensory threshold of a patient. In some embodiments, a vibratory output may be less than about 2 Gᵣₘₛ. Another aspect of the present disclosure can be used to apply stimulation around a circumference of a patient's wrist through a wristband which may allow for stimulation of five distinct somatosensory channels via the C5-T1 dermatomes as well as an additional fifteen proprioceptive channels via the tendons passing through the wrist. This may allow for a total of twenty distinct channels with a wristband formfactor which would also be much less cumbersome than an electrical glove or other formfactor.

In some embodiments, aspects of the present disclosure provide for a wearable device having a single mechanical transducer. A wearable device having a single mechanical transducer may have a smaller device profile than a wearable device with multiple transducers. In embodiments where a where a wearable device has a single mechanical transducer, the single mechanical transducer may be configured to provide a continuous vibratory output of about 0.78 Gᵣₘₛ, which may provide a reduction in one or more movement disorder symptoms as or more effectively than a wearable device with multiple transducers. For instance, a vibratory output of a single transducer at about 0.78 Gᵣₘₛ may reduce movement disorder symptom severity by about 1 point in acute improvement measurements with regards to BF-ADL scoring, and by about 2 points in cumulative improvement measurements with regards to BF-ADL scoring, which may be higher than improvement using multiple transducers and/or a frequency matched stimulation. A wearable device with a single mechanical transducer may be configured to provide auxiliary vibratory output that may assist in a patient experiencing difficulties while performing tasks requiring fine motor skills or other tasks.

### Device Overview

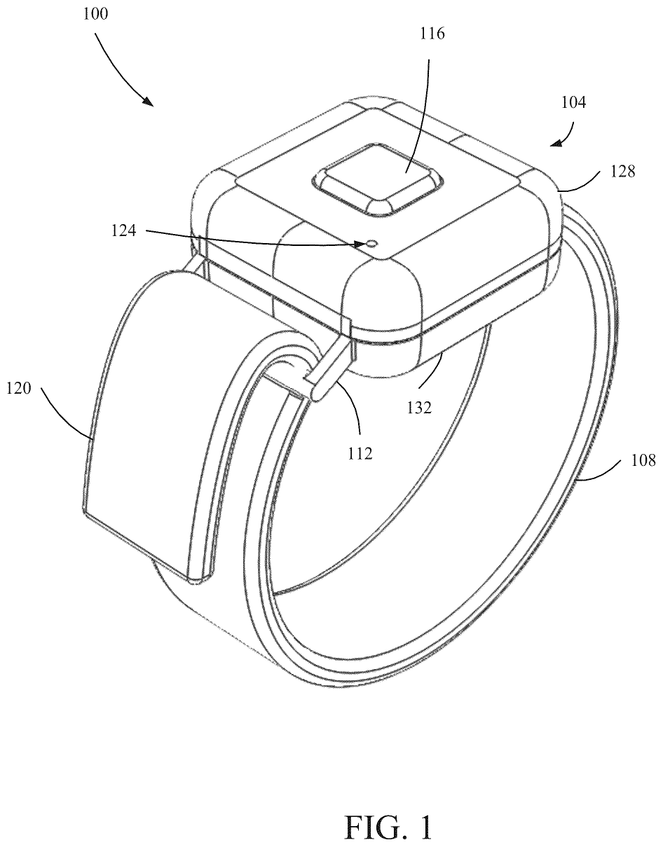

FIG. 1 shows an illustration of a wearable device 100. A “wearable device” as used in this disclosure refers to an object attachable or securable to a portion of the human body. Wearable device 100 may have a form such as, but not limited to, a wristband, smartwatch, arm band, glove, or other forms of garments. In some embodiments, the wearable device 100 may include housing 104. A “housing” as used in this disclosure refers to a structure having an interior designed to contain one or more components. Housing 104 may be designed to contain or otherwise secure one or more components of the wearable device 100. Housing 104 may have an interior volume of about, but not limited to, about 1 cubic centimeter (cc) to about 2 cc, about 3 cc to about 4 cc, about 4 cc to about 5 cc, about 5 cc to about 6 cc, about 6 cc to about 7 cc, about 7 cc to about 8 cc, about 8 cc to about 9 cc, about 9 cc to about 10 cc, about 10 cc to about 11 cc, about 11 cc to about 12 cc, about 12 cc to about 13 cc, about 13 cc to about 14 cc, about 14 cc to about 15 cc, about 15 cc to about 16 cc, about 16 cc to about 17 cc, about 17 cc to about 18 cc, about 18 cc to about 19 cc, about 19 cc to about 20 cc, or greater than about 20 cc. In some embodiments, housing 104 may be circular, ovular, rectangular, square, or other shapes. In some embodiments, housing 104 may have a length of about 5 inches, a height of about 5 inches, and a width of about 5 inches, without limitation. In some embodiments, the housing 104 may have a length of about 1.5 inches, a width of about 1.5 inches and a height of about 0.5 inches. In some embodiments, housing 104 may be water resistant. Housing 104 may be entirely waterproof, in some embodiments. For instance, a seal, such as, but not limited to, a hermetic seal may be placed a top of housing 104 and at a bottom of housing 104 which may prevent water or other liquids from entering housing 104.

Housing 104 may be made of a material such as, but not limited to, metal, plastic, polymers, or other materials. In some embodiments, housing 104 may be made of two or more materials. For instance, top surface 128 of housing 104 may be made of a first material while bottom surface 132 of housing 104 may be made of a second material. A second material may have a vibrational conductivity higher than that of a first material. A “vibrational conductivity” as used in this disclosure refers to a property of a material allowing kinetic energy to flow through the material. Vibrational conductivity may also be referred to as “acoustic impedance” interchangeably throughout this disclosure. Vibrational conductivity of any material of housing 104 may be about, but are not limited to, about 0.1×10⁶ kgm⁻²s⁻¹ to about 1×10⁶ kgm⁻²s⁻¹, about 1×10⁶ kgm⁻²s⁻¹ to about 2×10⁶ kgm⁻²s⁻¹, about 2×10⁶ kgm⁻²s⁻¹ to about 3×10⁶ kgm⁻²s⁻¹, greater than about 3'10⁶ kgm⁻²s⁻¹, or less than about 0.1×10⁶ kgm⁻²s⁻¹. A second material of bottom surface 132 of housing 104 may be designed to contact a surface of a body part of a patient. For instance, a second material of bottom surface 132 of housing 104 may be made of a cushioned material. A cushioned material may be, but is not limited to, non-woven material, synthetic fabrics, polyester, or other materials. In some embodiments, bottom surface 132 may conform to a geometry of a patient's body part. For instance, bottom surface 132 may be made of a flexible material which may allow bottom surface 132 to conform to a geometry of a patient's body part. A second material of bottom surface 132 of housing 104 may have a coefficient of friction higher than that of a first material of a top of housing 104. A higher coefficient of friction of a second material of bottom surface 132 may allow for wearable device 100 to more securely position itself on a body part of a patient compared to a lower coefficient of friction. Coefficients of friction of a first and/or second material may be, but are not limited to, about 0.1μ to about 1μ, greater than about 1μ, or less than about 0.1μ.

In some embodiments, a first material of housing 104, which may be incorporated top surface 128, may be made of a material having a higher rigidity than a second material of a bottom half of housing 104. A higher rigidity of a first material of housing 104 may allow for housing 104 to provide structural protection to one or more components within housing 104, such as, by resisting physical forces such as shear, stress, or other physical forces. Top surface 128 of housing 104 may be shaped differently than bottom surface 132 of housing 104. For instance, bottom surface 132 of housing 104 may be circular while top surface 128 of housing 104 may be square, or vice versa. In some embodiments, both top surface 128 and bottom surface 132 of housing 104 may be shaped similarly. Bottom surface 132 may be concave with respect to a longitudinal axis of wearable device 100, in some embodiments. A concavity of bottom surface 132 may allow for increased snugness of housing 104 to a round part of a patient's body, such as an arm, leg, or other body part. In some embodiments, a concavity of bottom surface 132 may be adjustable. For instance, bottom surface 132 may be made of a flexible material, which may conform to a patient's body part as tension is applied via wristband 108. Flexible materials may include, but are not limited to, rubber or other materials.

In some embodiments, housing 104 may include one or more interactive elements 116. An “interactive element” as used in this disclosure is a component that is configured to be responsive to user input. Interactive element 116 may include, but is not limited to, buttons, switches, touchscreens, knobs, sliders, keys, and the like. Interactive element 116 may be in communication with one or more components of a circuitry within housing 104. For instance, interactive element 116 may be in electrical communication with a processor stored within housing 104. A processor may be configured to perform one or more operations based on input received via interactive element 116. For instance, a processor may be configured to power on wearable device 100, power off wearable device 100, restart wearable device 100, adjust vibratory output, or other operations. In some embodiments the wearable device 100 may have a singular interactive element 116. In other embodiments, the wearable device 100 may have two or more interactive elements 116. In embodiments where the wearable device 100 has a plurality of interactive elements 116, each interactive element 116 may correspond to a different function. For instance, a first interactive element may correspond to a power function, a second interactive element may correspond to a waveform adjustment, a third interactive element may correspond to a mode of the wearable device 100, and the like.

In some embodiments, interactive element 116 may be a touch screen display. A touch screen display may be, but is not limited to, a liquid crystal display (LCD), organic light emitting diode display (OLED), or other display types. In some embodiments, a touch screen display may provide a patient with a user interface. A user interface may include one or more graphical icons that may correspond to data, functions, and the like. A user interface may display sensor data, vibrational stimulus output, icons corresponding to adjustments of a vibrational stimulus output, dates, times, battery levels, Wi-Fi connectivity, Bluetooth® connectivity, cellular connectivity, weather, or any other data described herein. In some embodiments, interactive element 116 may be in communication with one or more motors that may allow for haptic feedback to be received. “Haptic feedback” as used in this disclosure refers to a vibrational output that confers information to a user. For instance, interactive element 116 may provide haptic feedback upon receiving one or more inputs from a user, such as touchscreen inputs. Touchscreen inputs may include, but are not limited to, single taps, double taps, long presses, swipes, multi-touch input, or other forms of input.

Housing 104 may have visual indicator 124. A “visual indicator” as used in this disclosure is any light emitting device capable of conveying information through light emission. Visual indicator 124 may be an LED or other light emitting device. Visual indicator 124 may be positioned at a corner of top surface 128. For instance and without limitation, visual indicator 124 may be positioned at a bottom right, bottom left, top right, or top left position of top surface 128 in embodiments where top surface 128 may be square or rectangular. Visual indicator 124 may be circular, square, triangular, or other shapes. Visual indicator 124 may be in communication with a processor stored within housing 104. A processor may be configured to activate visual indicator 124 based on various inputs, such as, but not limited to, sensor data of power levels, vibratory output, or other data. Visual indicator 124 may emit a light colored red, blue, green, or combination thereof. In some embodiments, visual indicator 124 may flash over a period of time. A period of time may be, but is not limited to, about 1 second, less than about 1 second, or greater than about 1 second. In some embodiments, visual indicator 124 may flash a train of lights, each light in the train of lights separated by the same period of time. In some embodiments, visual indicator 124 may emit light over a long period of time, such as longer than about 5 seconds. Light emitted by visual indicator 124 may be indicative of, but is not limited to, power levels, positioning of wearable device 100, vibratory output of wearable device 100, confirmation of input received via interactive element 116, or other information.

In some embodiments, the wearable device 100 may include one or more batteries. For instance, and without limitation, the wearable device 100 may include one or more replaceable batteries, such as lead-acid, nickel-cadmium, nickel-metal hydride, lithium-ion, and/or other battery types. The housing 104 of the wearable device 100 may include a charging port that may allow access to a rechargeable battery of the wearable device 100. For instance and without limitation, the wearable device 100 may include one or more rechargeable lithium-ion batteries and a charging port of the housing 104 of the wearable device 100 may be a USB-C, micro-USB, and/or other type of port. A battery of the wearable device 100 may be configured to charge at a rate of about 10 W/hr. A battery of the wearable device 100 may be configured to charge using a voltage of about 3.7V with a current draw of about 630 mA. In some embodiments, a battery of wearable device 100 may have a charge rate of about, but not limited to, 1C to about 2C. A battery of the wearable device 100 may have a capacity of about 2.5 Wh, greater than 2.5 Wh, or less than 2.5 Wh, without limitation. In some embodiments, the wearable device 100 may include one or more wireless charging circuits that may be configured to receive power via electromagnetic waves. The wearable device 100 may be configured to be charged wirelessly at a rate of about 5 W/hr through a charging pad or other wireless power transmission system. In some embodiments, a battery of the wearable device 100 may be configured to be charged at about 460 mA, greater than 460 mA, or less than 460 mA.

Still referring to FIG. 1, the wearable device 100 may include an attachment system. An attachment system may include any component configured to secure two or more elements together. For instance, and without limitation, the wearable device 100 may include a wristband 108. The wristband 108 may include one or more layers of a material. For instance and without limitation, the wristband 108 may include multiple layers of a polymer, such as, but not limited to, rubber. The wristband 108 may have an interior and an exterior. An interior and an exterior of the wristband 108 may be the same material, texture, and the like. In other embodiments, an interior of the wristband 108 may be softer and/or smoother than an exterior of the wristband 108. As a non-limiting example, an interior of the wristband 108 may be a smooth rubber material while an exterior of the wristband 108 may be a Velcro material. The wristband 108 may have a thickness of about 2 mm. In other embodiments, the wristband 108 may have a thickness of greater than or less than about 2 mm. Wristband 108 may be about 4 mm thick, in some embodiments. The wristband 108 may be a rubber band, Velcro® strap, and the like. Wristband 116 may be manipulated through loop 120. Loop 120 may be an end of wristband 108 that may be passed through hook 112. A patient may pull on loop 120, which may cause a shortening of wristband 116. In some embodiments, a patient may pull on wristband 108, which may cause loop 120 to shorten with respect to hook 112. Loop 120. In some embodiments, the wristband 108 may be adjustable. For instance, the wristband 108 may have loop 120 that may self-attach through a Velcro® attachment system. In some embodiments, the wristband 108 may attach to one or more hooks 112 of an exterior of the housing 104 of the wearable device 100. In some embodiments, the wristband 108 may be magnetic. In other embodiments, the wristband 108 may include a column, grid, or other arrangement of holes that may receive a latch from the hook 112.

In some embodiments, one or more components of the wearable device 100 may be the same as described in U.S. application Ser. No. 16/563,087, filed Sep. 6, 2019, and titled “Apparatus and Method for Reduction of Neurological Movement Disorder Symptoms Using Wearable Device”, the entirety of which is incorporated herein by reference.

### Anatomical Illustrations

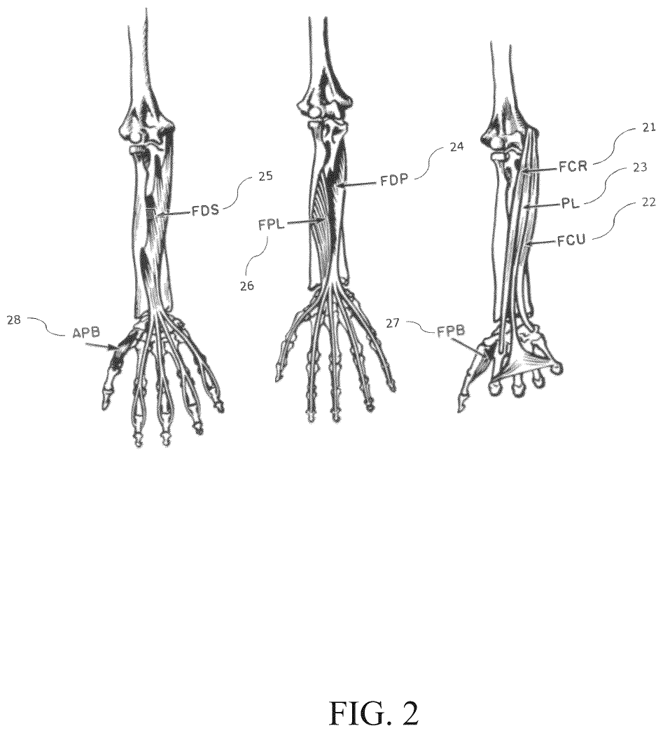

FIGS. 2-5 illustrate various anatomies of the human body. Devices, processes, and systems described herein may target and/or provide vibratory output to any anatomical location described herein.

FIG. 2 shows the flexor muscles and tendons of the wrist, fingers, and thumb. The flexors of the wrist are selected from the group consisting of the Flexor Carpi Radialis (FCR) 21, Flexor Carpi Ulnaris (FCU) 22, and the Palmaris Longus (PL) 23. The flexors of the fingers are selected from the group consisting of the Flexor Digitorum Profundus (FDP) 24 and the Flexor Digitorum Superficialis (FDS) 25. The flexors of the thumb are selected from the group consisting of the Flexor Pollicis Longus (FPL) 26, the Flexor Pollicis Brevis (FPB) 27 and the Abductor Pollicis Brevis (APB) 28.

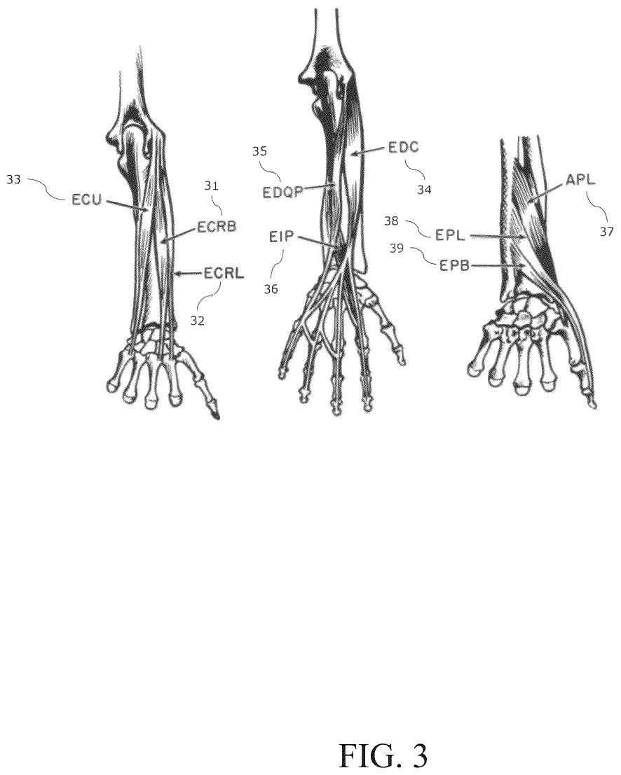

FIG. 3 shows the extensor muscles and tendons of the wrist, fingers, and thumb. The extensors of the wrist are selected from the group consisting of the Extensor Carpi Radialis Brevis (ECRB) 31, Extensor Carpi Radialis Longus (ECRL) 32, and the Extensor Carpi Ulnaris (ECU) 33. The extensors of the fingers are selected from the group consisting of the Extensor Digitorum Communis (EDC) 34, Extensor Digiti Minimi (EDM) or Extensor Digiti Quinti Proprius (EDQP) 35, and the Extensor Indicis Proprius (EIP) 36. The extensors of the thumb are selected from the group consisting of the Abductor Pollicis Longus (APL) 37, Extensor Pollicis Longus (EPL) 38, and the Extensor Pollicis Brevis (EPB) 39.

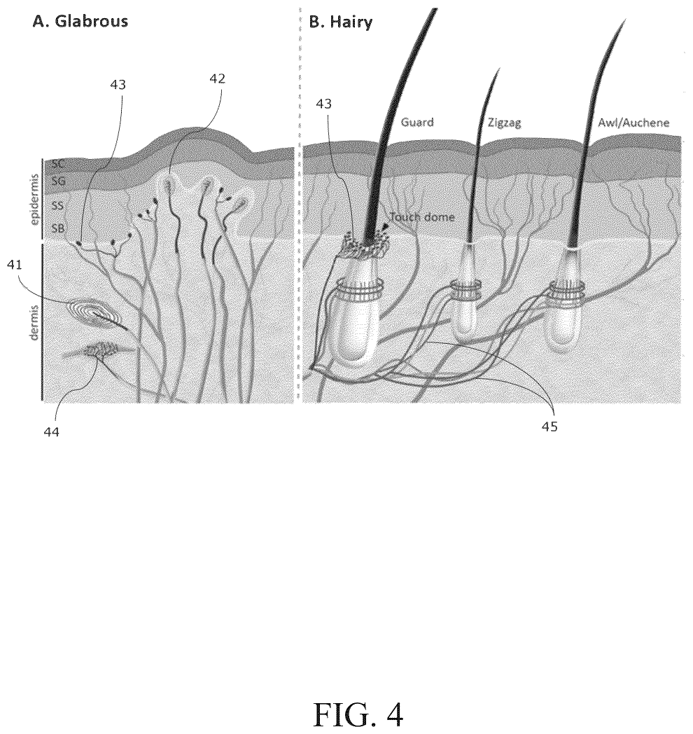

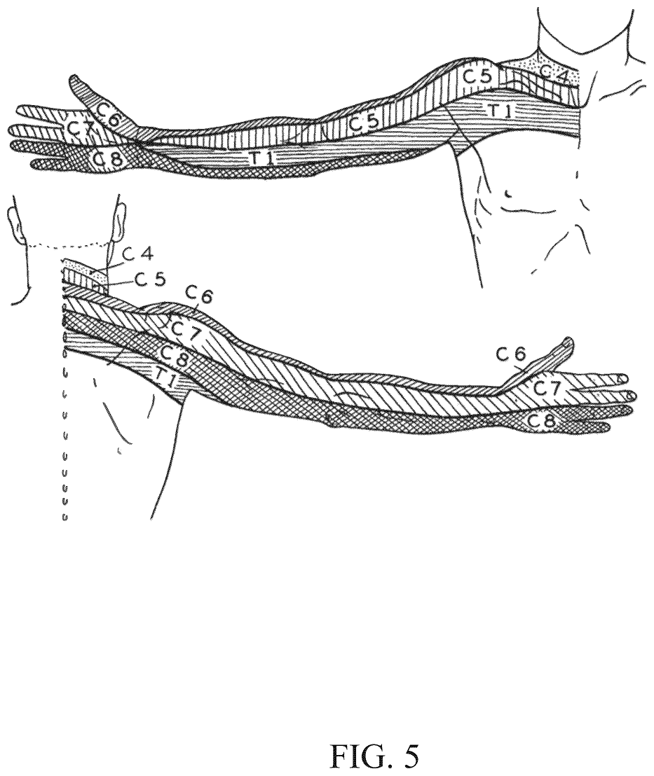

FIG. 4 illustrates various somatosensory afferents that may be targeted. The somatosensory afferents may be a subset of cutaneous mechanoreceptors. The set of cutaneous mechanoreceptors includes the Pacinian corpuscles 41, Meissner corpuscles 42, Merkel complexes 43, Ruffini corpuscles 44, and C-fiber low threshold mechanoreceptors (C-LTMR). The Pacinian corpuscle (PC) 41 is a cutaneous mechanoreceptor that responds primarily to vibratory stimuli in the frequency range of 20-1000 Hz. Meissner corpuscles 42 are most sensitive to low-frequency vibrations between 10 to 50 Hertz and can respond to skin indentations of less than 10 micrometers. Merkel nerve endings 43 are the most sensitive of the four main types of mechanoreceptors to vibrations at low frequencies, around 5 to 15 Hz. Ruffini corpuscles 44 are found in the superficial dermis of both hairy and glabrous skin where they record low-frequency vibration or pressure at 40 Hz and below. C-LTMR 45 are present in 99% of hair follicles and convey input signals from the periphery to the central nervous system. The present disclosure focuses on the stimulation of cutaneous mechanoreceptors in the upper limb dermatomes innervated by the C5, C6, C7, C8, and T1 spinal nerves, which are depicted in FIG. 5 and labeled according to the corresponding spinal nerve.

FIG. 5A shows the locations of the upper limb dermatomes innervated by the C5, C6, C7, C8, and T1 spinal nerves from a front view.

FIG. 5B shows the locations of the upper limb dermatomes innervated by the C5, C6, C7, C8, and T1 spinal nerves from a rear view.

### Mechanical Transducers

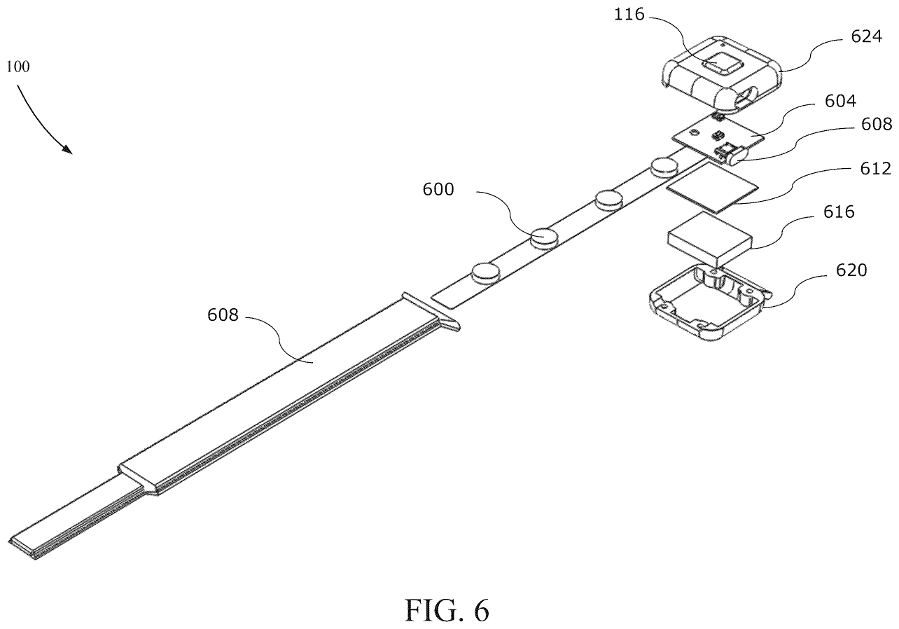

Referring now to FIG. 6, an exploded side view of the wearable device 100 is shown. The wearable device 100 may be the same as described above with reference to FIG. 1, without limitation. The wearable device 100 may include mechanical transducers 600. A “mechanical transducer” as used in this disclosure refers to a device capable of receiving a first form of energy and converting the first form of energy into vibratory output. Mechanical transducers 600 may also be referred to as “transducers 600” throughout this disclosure. Mechanical transducers 600 may be, but are not limited to, eccentric rotating mass (ERM) motors, linear resonant actuators (LRAs), coin motors, brushless coin motors, or other types of motors. Mechanical transducers 600 may be circular, rectangular, or other shapes. In some embodiments, mechanical transducers 600 may have a width of about 0.1 inch to about 0.5 inches. In some embodiments, one mechanical transducer may be larger or smaller than one or more other mechanical transducers. In other embodiments, each mechanical transducer 600 may be the same size. Wearable device 100 may have two or more mechanical transducers 600. In some embodiments, wearable device 600 may have a single mechanical transducer 600. In embodiments where wearable device 100 has multiple mechanical transducers 600, each mechanical transducer 600 may be positioned about 1 mm to about 200 mm away from each other. In some embodiments, mechanical transducers 600 may be arranged along wrist band 608 to target one or more sensory areas of a patient. Sensory areas may include, but are not limited to, the C5, C6, C7, C8, and/or T1 spinal nerves. Each transducer of mechanical transducers 600 may be configured to provide a vibratory output. A “vibratory output” as used in this disclosure refers to a mechanical waveform. In some embodiments, each mechanical transducer 600 may be configured to provide a different vibratory output than one or more other mechanical transducers 600. For instance, based on a positioning of a mechanical transducer 600, a certain vibratory output may be produced to target a specific sensory area of a patient. In some embodiments, each mechanical transducer 600 may be configured to provide a same vibratory output. In some embodiments, one or more mechanical transducers 600 may protrude out of wrist band 608 such that they make direct contact with a patient's body. In other embodiments, wrist band 608 may act as a sheath and may contain one or more mechanical transducer 600. In embodiments where mechanical transducers 600 are positioned within wrist band 608, one or more mechanical transducers 600 may be in contact with an interior surface of wrist band 608. Wrist band 608 may be made of a thin material, which may enable vibratory output produced by one or more mechanical transducers 600 to conduct through a material of wrist band 608 more easily than if wrist band 608 were made of a thicker material. For instance, wrist band 608 may have a thickness on each side of about 0.05 inches to about 0.5 inches.

Wrist band 608 may be configured to interface with a patient's writs. For instance, wrist band 608 may wrap around a patient's wrist or other part of a patient. Wrist band 608 may secure itself via Velcro®, magnetic connectors, hooks, or other forms of connection. Wearable device 100 may have top surface 624 and bottom surface 620. In some embodiments, between top surface 624 and bottom surface 620, a printed circuit board 604 (PCB) may be positioned. Further, a silicone square 612 may be positioned to insulate a bottom of PCB 604, which may be positioned above a battery 616. Battery 616 may include protection circuitry to protect from overcharging and unwanted discharging. In some embodiments, wearable device 100 may include a magnetic connector 628. Magnetic connector 628 may be configured to align wearable device 100 with a charging pad, station, and the like. Magnetic connector 628 may be configured to receive power wirelessly to recharge battery 616. Magnetic connector 628 may be coupled to battery 616 and mounted in housing 620 or positioned in top surface 624. In some embodiments, magnetic connector 628 may be inserted into the PCB 604. Magnetic connector 628 may be configured to mate with a connector from an external charger.

Mechanical transducers 600 may be configured to vibrate at up to or more than 200 kHz, in an embodiment. In another embodiment, mechanical transducers 600 may be configured to vibrate at about 100-300 Hz. In another embodiment, mechanical transducers 600 may be configured to modulate a carrier frequency of above 100 Hz with a signal frequency between 3 Hz and 30 Hz. Mechanical transducers 600 may draw energy from one or more batteries from wearable device 100. For instance, mechanical transducers 600 may draw about 5 W of power from a battery 616 of wearable device 100. In some embodiments, mechanical transducers 600 may have a max current draw of about 90 mA, a current draw of about 68 mA, a 34 mA current draw at 50% duty cycle, and may have a voltage of about 0V to about 5V, without limitation.

Still referring to FIG. 6, in some embodiments, a processing unit of the PCB 604 may communicate a vibratory output with one or more mechanical transducers 600 of wearable device 100. A vibratory output may have, but is not limited to having, an amplitude, frequency, peak-to-peak width, or other parameters. In some embodiments, a processing unit of PCB 604 may calculate one or more waveform parameters of a vibratory output based on sensor data received from one or more sensors of wearable device 100. Sensors may include, but are not limited to, accelerometers, electrocardiogram (ECG) sensors, gyroscopic sensors, inertia measurement units (IMU), or other sensor types. In some embodiments, a processing unit of PCB 604 may be configured to determine one or more waveform parameters based on a current set of waveform parameters and/or sensor data received from one or more sensors.

In some embodiments, a processing unit of PCB 604 may be configured to command one or more mechanical transducers 600 to provide a vibratory output. For instance, a vibratory output produced by or more transducers 600 may have a vibrational strength of about 50 mGᵣₘₛ to about 2 Gᵣₘₛ. A “vibrational strength” as used in this disclosure refers to the root mean squared value of acceleration. In some embodiments, a vibratory output of one or more transducers 600 may have a vibrational strength of less than 1 Gᵣₘₛ or greater than 50 mGᵣₘₛ. In some embodiments, a vibratory output of transducers 600 may have a vibrational strength of about 0.5 Gᵣₘₛ to about 0.5 Gᵣₘₛ, about 0.6 Gᵣₘₛ to about 0.7 Gᵣₘₛ, about 0.7 Gᵣₘₛ to about 0.8 Gᵣₘₛ, about 0.8 Gᵣₘₛ to about 0.9 Gᵣₘₛ, or about 0.9 Gᵣₘₛ to about 1.0 Gᵣₘₛ, In some embodiments, a vibratory output of one or more mechanical transducers 600 may have a vibrational strength of about 0.78 Gᵣₘₛ. In some embodiments, each mechanical transducer of mechanical transducer 600 may be configured to provide a different vibrational intensity of a vibratory output. In some embodiments, each mechanical transducer 600 of mechanical transducers 600 may be configured to provide a same vibrational intensity of a vibrational output. In some embodiments, a vibrational intensity of each mechanical transducer of mechanical transducers 600 may sum to a total value of about 0.78 Gᵣₘₛ to about 4 Gᵣₘₛ. In some embodiments, each mechanical transducer 600 may be configured to provide a vibratory output having a vibrational strength of about 0.78 Gᵣₘₛ to about 4 Gᵣₘₛ. Mechanical transducers 600 may provide a vibratory output to a single sensory area, such as one of, but not limited to, C5, C6, C7, C8, and/or T1 spinal nerves. In some embodiments, each mechanical transducer of mechanical transducers 600 may be arranged to contact a sensory area different from one or more other mechanical transducers 600. For instance and without limitation, a first mechanical transducer may be arranged to provide vibratory output to the C5 nerve, while a second mechanical transducer may be arranged to provide vibratory output to the C6 nerve and so on. In some embodiments, two or more mechanical transducers may be arranged to provide vibratory output to the same sensory area. Mechanical transducers 600 may be positionable along wrist band 608. For instance, an original positioning of one or more mechanical transducers 600 may be changed to target various sensory areas. Mechanical transducers 600 may be positioned in a rack and/or may be configured to slide within a surface, which may allow for a changing in position of one or more mechanical transducers 600.

A vibratory output may cause between about a 5% to about a 30% reduction in tremor measurements of a patient compared to a reduction in tremor measurements of the patient provided by inactive simulation. Inactive stimulation may be a vibratory output having zero amplitude and/or zero frequency. Tremor measurements may include, but are not limited to, peak tremor power, Brain and Findley Activities of Daily Living (BF-ADL) scores, and/or The Essential Tremor Rating Assessment Scale (TETRAS) scores. In some embodiments, one or more vibratory outputs produced by one or more mechanical transducers 600 may, when applied to one or more sensory areas of a patient, reduce a severity of one or more movement disorder symptoms by about, but not limited to, about 5% to about 10%, about 10% to about 15%, about 15% to about 20%, about 20% to about 25%, about 25% to about 30%, about 30% to about 35%, about 35% to about 40%, about 40% to about 45%, about 45% to about 50%, about 50% to about 55%, about 55% to about 60%, about 60% to about 65%, about 65% to about 70%, about 70% to about 75%, about 75% to about 80%, about 80% to about 85%, about 85% to about 90%, or greater than about 90%. A “severity of a movement disorder symptoms” as used in this disclosure refers to a relative intensity or amplitude of a movement disorder symptom, such as, but not limited to, tremors, shaking, or other symptoms described herein. Reduction in a severity in one or more movement disorder symptoms may be measured by calculating a difference between a baseline severity of one or more movement disorder symptoms and a severity of one or more movement disorder symptoms during and/or after treatment.

In some embodiments, wearable device 100 may include one or more sensors that may be configured to detect a severity of a movement disorder symptom of a patient. A processing unit of PCB 604 may be configured to calculate a difference in severity of one or more movement disorder symptoms of a patient before treatment and during and/or after treatment. Treatment may include applying a vibratory output to one more sensory areas of a patient. A processing unit of PCB 604 may calculate effectiveness of treatments based on a difference in severity of one or more movement disorder symptoms of a patient. An “effectiveness of a treatment” as used in this disclosure refers to a percentage reduction in severity of one or more movement disorder symptoms of a patient after and/or during treatment. A processing unit of PCB 604 may be configured to adjust a vibrational strength and/or frequency of a vibratory output based on a calculated effectiveness of a treatment of providing vibratory output to one or more sensory areas of a patient. In some embodiments, a processing unit of PCB 604 may be configured to communicate sensor data, vibratory output data, effectiveness data, and/or any other data through a wireless communication unit of wearable device 100. A wireless communication unit of wearable device 100 may include, but is not limited to, a Wi-Fi chip, Bluetooth®, cellular network, or any other type of wireless communication unit. Wearable device 100 may be in communication with a display via a wireless communication unit. A display may be, but is not limited to, a monitor, laptop, smartphone, tablet, or other device. Wearable device 100 may be configured to cause a display in communication with wearable device 100 to show sensor data, treatment effectiveness, vibratory output data, or any other data described herein. A display may show trends in vibratory output data, sensor data, effectiveness of treatment data, and/or other data.

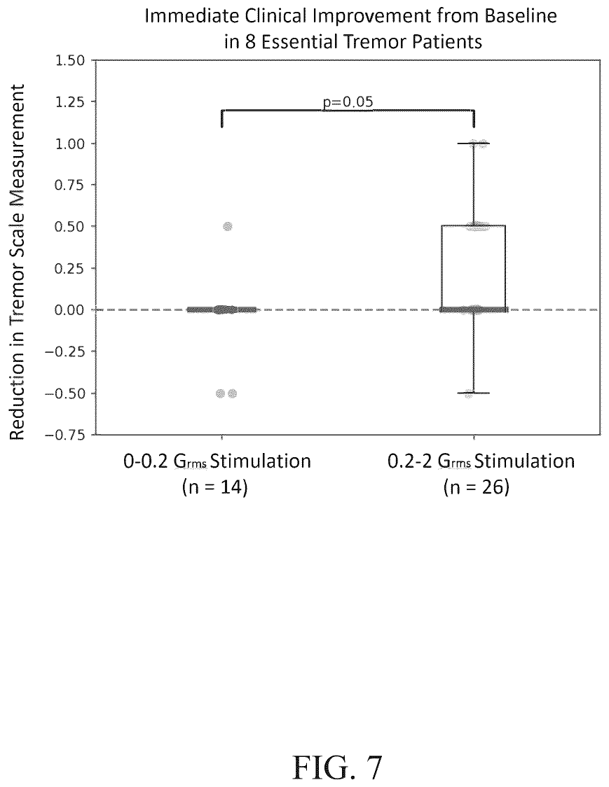

Vibratory outputs of mechanical transducers 600 having a vibration between about 50 mGᵣₘₛ to about 2 Gᵣₘₛ may reduce peak tremor power of a tremor in a patient by about 10% to about 50% or greater compared to a baseline peak tremor value. Vibratory outputs of mechanical transducers 600 may cause an acute improvement in tremor measurements of a patient by about 25% to about 50% or greater with respect to an original test metric, such as, but not limited to, BF-ADL and/or TETRAS scoring systems. An “acute improvement” refers to an improvement that occurs during a single therapy session using vibratory outputs of mechanical transducers 600. In some embodiments, vibratory outputs of mechanical transducers 600 may cause a cumulative improvement in tremor measurements by about 25% to about 50% compared to a baseline value. A “cumulative improvement” refers to a measurement of symptoms over one or more days. For instance, a cumulative improvement may be measured across about 3 days to about 5 days of stimulation therapy provided by vibratory outputs of mechanical transducers 600. A vibratory output of mechanical transducers 600 may be frequency matched to a movement disorder symptom of a patient, such as, but not limited to, an essential tremor of a patient. “Frequency matched” as used in this disclosure refers to generating a vibratory output having a same frequency as one or more movement disorder symptoms. A processor of PCB 604 may calculate a frequency of one or more movement disorder symptoms of a patient and may generate a vibratory output having a same frequency as the one or more movement disorder symptoms of the patient. An “essential tremor” as used in this disclosure refers to a neurological condition that causes involuntary shaking. A frequency matched vibratory output may target one or more of C5, C6, T1, and C8 dermatomes of a patient. A vibratory output of transducers 600 may include a phase reset stimulation. A phase reset stimulation may target one of C5, C6, T1, or C8 dermatomes of a patient and may be a single pulse. Vibratory outputs of mechanical transducers 600 may provide therapeutic relief and/or improvement from tremors and/or tremor symptoms as shown in the test results of FIGS. 7-14 below.

Referring still to FIG. 6, in some embodiments, a vibratory output of mechanical transducers 600 may have a vibrational strength of about 0.30 Gᵣₘₛ to about 0.78 Gᵣₘₛ. A vibrational output of transducers 600, when applied to a patient, may have less than about a 30% perception of stimulation rate. A “perception of stimulation rate” as used in this disclosure refers to a percentage of patients that report sensing a vibratory output provided by transducers 600. In some embodiments, a vibratory output of transducers 600 may have an imperceptibility rate of about 70%. An “imperceptibility rate” as used in this disclosure refers to a percentage of patients that report not sensing a vibratory output of transducers 600. A vibratory output of mechanical transducers 600 may be applied to one or more nerves in a vicinity of a wrist of a patient. A vicinity may be a proximity within a 10 cm or greater radius from a wrist of a patient. A vibrational strength of a vibratory output of mechanical transducers 600 may be below a subsensory threshold of a patient. A “subsensory threshold” as used in this disclosure refers to a value or range of values of stimulation that are imperceptible to a patient. For instance, a subsensory threshold may be greater or less than about 3 Gᵣₘₛ. Vibratory outputs of one or more mechanical transducers 600 may provide a reduction in severity of one or more movement disorder symptoms of a patient while being imperceptible to the patient. An imperceptibility of vibratory output of one or more mechanical transducers 600 may enable longer wear time of wearable device 100 as the patient may not sense vibratory output being applied to the patient. Longer wear time may be longer than, but not limited to, 5 minutes, 30 minutes, an hour, or longer than an hour. A vibratory output of mechanical transducers 600 may have a frequency of about 0.1 Hz to about 4 Hz, about 4 Hz to about 6 Hz, less than about 1 Hz, or greater than about 6 Hz, without limitation. In some embodiments, a vibratory output of mechanical transducers 600 may have a frequency of about 1/10 Hz to about 1 Hz, less than about 1/10 Hz, or greater than about 1 Hz. A frequency of a vibratory output of mechanical transducers 600 may be calculated as a subharmonic of a tremor frequency of a patient. For instance and without limitation, a frequency of a vibratory output of mechanical transducers 600 may be calculated as about 1/30^{th} to about 1/120^{th} of a frequency of a tremor of a patient. In some embodiments, a frequency of a vibratory output may be about 1/30^{th} of a frequency of a tremor of a patient to about 1/120^{th} of a frequency of a tremor of a patient. An amplitude of a vibratory output may be continuous, for instance in the form of a pulse waveform. In some embodiments, a vibratory output may be a square wave with about a 50% duty cycle with an amplitude of about 0.5 Gᵣₘₛ to about 10 Gᵣₘₛ. A vibratory output may have a fixed pulse width of about between 10 ms to about 100 ms. In some embodiments, a vibratory output may be frequency matched to a 1/48^{th} subharmonic of a patient's tremor with an amplitude of about 0.1 Gᵣₘₛ. In embodiments where vibratory output is a pulse waveform, the vibratory output may have a pulse of about, but not limited to, 0.1 to about 1 s, 1 s to about 2 s, or greater than about 2 s. In some embodiments, a pulse of a pulse waveform of a vibratory output may occur asymmetrically within a time period. For instance, pulses within a pulse waveform may be separated by different periods of time. In some embodiments, pulses in a pulse waveform may each be separate by a same amount of time and may have a synchrony across a period of time. In some embodiments, an amplitude of a vibratory output may increase or decrease with time, such as in a sinusoidal-like fashion.

In some embodiments, mechanical transducers 600 may be configured to output a continuous single pulse waveform. In some embodiments, wearable device 100 may include a single mechanical transducer 600 that may be configured to output a continuous single pulse waveform. In some embodiments, wearable device 100 may include a single mechanical transducer 600 that may be configured to output a repeatable single pulse waveform. In some embodiments, a processor of PCB 604 may be configured to activate one or more mechanical transducers 600 to provide a high intensity frequency vibratory output additionally or alternatively to a continuous and/or repeatable single pulse output. For instance, a processor of PCB 604 may be configured to detect variations in a patient's tremor frequency, amplitude, or other parameters from one or more sensors and may activate mechanical transducers 600 to provide auxiliary stimulation to the patient. In some embodiments, a patient may select a high-frequency or other output of mechanical transducer 600 to assist in activities that may be effected by tremor symptoms. For instance, a patient may interact with interactive element 116 which may cause a processor of PCB 604 to activate one or more mechanical transducers 600 to provide an increased frequency and/or intensity of a vibrational output compared to a lower continuous single pulse output with a frequency of about 0.1 Hz to about 4 Hz, or about 4 Hz to about 6 Hz, and having an intensity of about 0.30 Gᵣₘₛ to about 0.78 Gᵣₘₛ. A high frequency output, which may be auxiliary to a low intensity continuous single pulse output, may have a frequency of greater than about 6 Hz and/or an intensity of greater than about 0.78 Gᵣₘₛ. For instance, a high frequency output may have a vibrational strength of about 3 Gᵣₘₛ to about 8 Gᵣₘₛ. An auxiliary high frequency output may be provided for a duration of a task a patient may perform. Tasks may include movements that require fine motor skills, such as, but not limited to, drawings, writing, painting, holding one or more objects, and/or any other movements.

In some embodiments, wearable device 100 may be configured to operate in an always-on mode. An “always-on mode” refers to a process in which a device continuously operates. For instance, a patient may activate wearable device 100 by interacting with interactive element 116 which may cause activation of one or more mechanical transducers 600. One or more mechanical transducers 600 may continuously output a single pulse vibratory output, which may have a vibrational strength of about 0.30 Gᵣₘₛ to about 0.9 Gᵣₘₛ. In some embodiments, a vibrational strength may be about 0.5 Gᵣₘₛ to about 4 Gᵣₘₛ or greater. In an always-on mode, wearable device 100 may terminate a vibratory output in response to a patient deactivating wearable device 100 through interactive element 116. In some embodiments, wearable device 100 may operate in an always-on mode until a preset time, or for a preset duration of time, which may be programmed into a processor of PCB 604. Wearable device 600 may be configured to cycle through one or more modes, such as, but not limited to, a closed-loop feedback mode, always-on mode, auxiliary output mode, or a combination thereof. A closed-loop feedback mode may input sensor data of one or more movement disorder symptoms of a patient and/or a current set of parameters of a vibratory output and may generate a vibratory output. An auxiliary output mode may provide variations in vibratory output alongside or alternative to a single continuous pulse having a constant vibrational strength. In some embodiments, one or more sensors of wearable device 100 may detect activity of a patient, a change in positioning of a patient's body part, or other information, which may cause a processor of PCB 604 to switch through one or more modes. As a non-limiting example, a patient may activate wearable device 100 to be in an always-on mode. A processor of PCB 604 may determine that a patient has started drawing or writing, and may switch to a closed-loop mode or an auxiliary mode.

In some embodiments, wearable device 100 may have a single mechanical transducer. A single mechanical transducer may be positioned within wrist band 608 to contact one or more of C5, C6, C7, C8, and/or T1 sensory areas. A single mechanical transducer may be configured to provide a continuous vibratory output having a vibrational strength of about 0.78 Gᵣₘₛ to about 4 Gᵣₘₛ or greater. In some embodiments, a single mechanical transducer may be configured to provide a vibratory output having a vibrational strength of less than about 0.78 Gᵣₘₛ. A single mechanical transducer may be configured to adjust a vibrational intensity of a vibratory output from between 0 Gᵣₘₛ to about 10 Gᵣₘₛ or greater. A patient may adjust a vibrational intensity of a vibratory output through interactive element 116. In some embodiments, a processor of PCB 604 may be in communication with one or more sensors and may be configured to adjust a vibratory output of a single mechanical transducer based on sensor data. A vibratory output provided by a single mechanical transducer may have a frequency of about 1 Hz to about 10 Hz. In some embodiments, frequencies and/or vibrational strengths of a vibratory output of a single mechanical transducer may be preset. In other embodiments, vibratory outputs of a single mechanical transducer may be adjusted during a diagnostic phase. In a diagnostic phase, vibratory output parameters of a single mechanical transducer may be adjusted until one or more movement disorder symptoms reach a desired level of severity. Adjustment may occur through a processor of PCB 604 in response to one or more sensor signals generated by one or more sensors. In embodiments where a wearable device 100 has a single mechanical transducer, an overall volume of wearable device 100 may be decreased compared to embodiments where wearable device 100 has multiple mechanical transducers 600. For instance, in embodiments where wearable device 100 has a single mechanical transducer, a height of wearable device 100 may be about 1.5 inches to about 2 inches, a width of wearable device 100 may be about 0.5 inches to about 1 inch, and a thickness of wearable device 100 may be about 0.25 inches to about 0.5 inches. Power consumption in embodiments where wearable device 100 has a single transducer may be less than power consumption of multiple mechanical transducers 600. For instance, in embodiments where wearable device 100 has a single mechanical transducer, operation of the single mechanical transducer may draw about 5 W or less of power from battery 616 of wearable device 100. Battery 616 may be reduced in size in embodiments where wearable device 100 has a single mechanical transducer. For instance, battery 616 may have a battery capacity of about 4,000 mAh or less. For instance, in embodiments where wearable device 100 has a single mechanical transducer, battery 616 may have a battery capacity of about 10 mAh to about 100 mAh, which may result in a battery life of about or greater than 10 hours. A reduced battery size and/or capacity may further aid in reducing an overall size of wearable device 100. Operation of a single mechanical transducer may allow wearable device 100 to have a long battery life. A “battery life” as used in this disclosure refers to an amount of time between a full charge and a depleted charge of a device. Wearable device 100 may have a battery life may range from about 1 day to about 1 week or more. In embodiments where wearable device 100 has a single mechanical transducer, a battery life of wearable device 100 may be increased compared to embodiments where wearable device 100 has multiple mechanical transducers 600. For instance, a battery life of wearable device 100 having a single mechanical transducer may be between about 5 days to greater than about 1 week. In embodiments where wearable device 100 has a single mechanical transducer, wearable device 100 may have a weight of about 1 g to about 1 kG. In some embodiments, wearable device 100 may be about 20 g to about 60 g.

### Test Results and Example Data

FIG. 7 is a box and whisker plot showing the immediate improvement from baseline in hand tremor rating in 8 Essential Tremor patients subject to stimulation of varying intensities, in accordance with an embodiment of the present disclosure. In some embodiments, a suprasensory vibration may have an acceleration greater than or equal to 50 mGᵣₘₛ. In some embodiments, a suprasensory vibration may have an acceleration between 200 mGᵣₘₛ and 2 Gᵣₘₛ. In some embodiments, a subsensory vibration may have an acceleration between 0 and 50 mGᵣₘₛ.

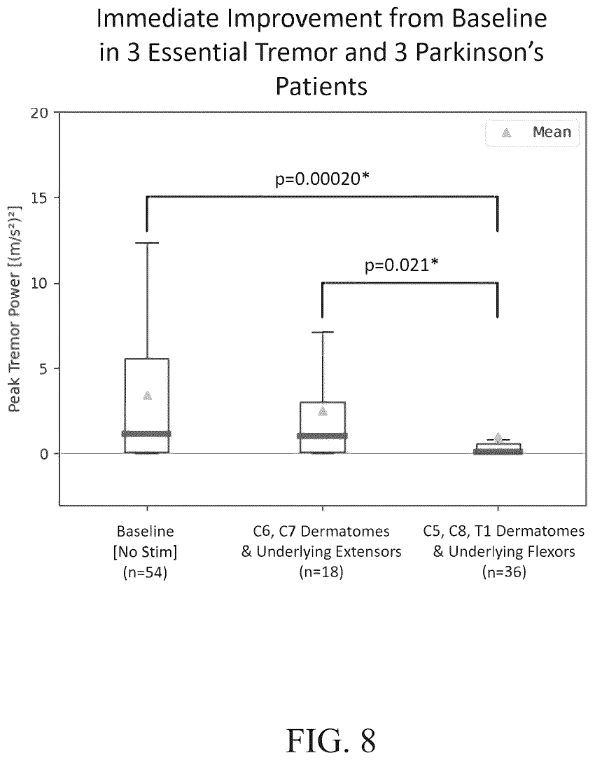

FIG. 8 is a box and whisker plot showing the immediate improvement from baseline in hand tremor rating in 3 Essential Tremor and 3 Parkinson's tremor patients subject to stimulation of varying anatomic targets, in accordance with an embodiment of the present disclosure. In some embodiments, and without limitation, a stimulation may be applied to at least one of the C5, C8, or T1 dermatomes. In some embodiments, and without limitation, a stimulation may be applied to at least one of the Flexor Carpi Radialis (FCR), the Flexor Carpi Ulnaris (FCU), the Palmaris Longus (PL), the Flexor Digitorum Profundus (FDP), the Flexor Digitorum Superficialis (FDS), and/or the Flexor Pollicis Longus (FPL). In some embodiments, the stimulation may be configured to alternate between targeting the flexors and the extensors of the wrist and hand.

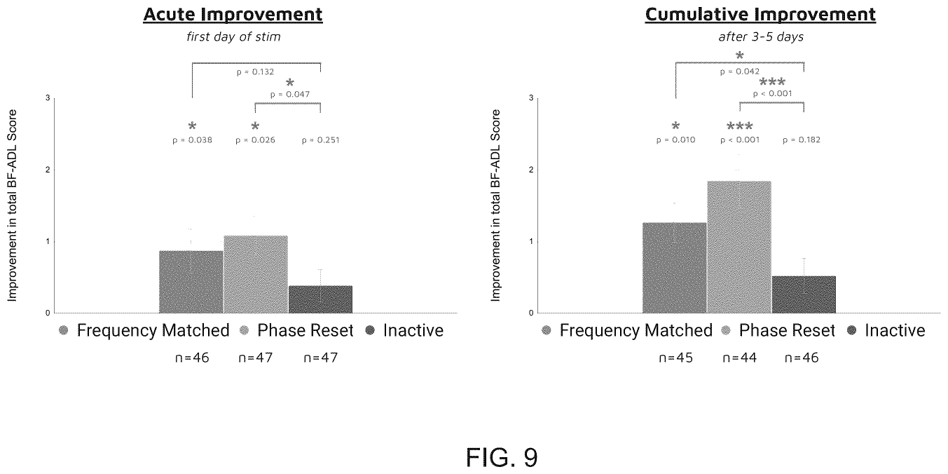

FIG. 9 illustrates test results showing acute and cumulative improvement in subjects using frequency matched, phase reset, and inactive stimulation. The test was a randomized, double blinded, sham controlled trial to evaluate safety, tolerability, and response to therapy. The patient population included subjects with moderate to sever essential tremor. The test lasted about 4 weeks with 47 patients being evaluated daily with a three arm crossover. A baseline measurement of tremor severity and/or essential tremor occurred over a span of 5 days. Arms of subjects were randomized and cross overed three times over a span of about 5 days. A first arm of each subject was provided with either an inactive sham where there was no stimulation, a phase reset stimulation, or a frequency matched essential tremor stimulation. The phase reset stimulation included a single pulse low intensity stimulation aimed at one motor, the C8 dermatome. The frequency matched stimulation was entrained to a tremor frequency of the subject and had a high intensity of about 0.78 Gᵣₘₛ per motor. The frequency matched stimulation was aimed at 4 motors, the C5, C6, T1, and C8 dermatomes. After the 5 days of randomized testing, there was a 2 day washout period for the subjects followed by another 5 days of a second randomized arm testing which was followed by another 2 day washout period. A third period of randomized arm testing over 5 days occurred after the second washout period, at which point the study concluded.

The demographics were randomized. Females made up 53% of the subjects while males made up 47%. The average age of patients was about 65.5 years within a deviation of +/−9.5 years. An age of onset greater than or equal to 50 years old was present in 72% of the subjects, while an age of onset of less than 50 years of age was present in 26% of the subjects. 96% of the subjects were white and 100% of the subjects were non-Hispanic or non-Latino. 74% of the subjects has a family history of essential tremor (ET) while 15% did not and 11% were unknown. 55% were responsive to alcohol, 19% were not, and 26% were unknown. 83% of the subjects fit a definite criteria for TRIG while 17% fit a probable criteria for TRIG. 55% of the subjects reported propranolol use, 30% reported primidone use, 6% reported gabapentin use, 0% reported Neurontin use, 15% reported topiramate use, 0% reported clonazepam use, 0% reported Botox use, and 4% reported marijuana use.

The phase reset stimulation included a single pulse low intensity stimulation with a frequency of about 0.125 Hz and having an intensity of about 0.30 Gᵣₘₛ aimed at one motor, the C8 dermatome. The frequency matched stimulation was entrained to a tremor frequency of the subject and had a high intensity of about 0.78 Gᵣₘₛ per motor. The frequency matched stimulation was aimed at 4 motors, the C5, C6, T1, and C8 dermatomes. The inactive simulation had no vibratory output. Improvements in movement disorder symptoms were measured using total BF-ADL scores.

For acute improvement, stimulation occurred over the course of a day. Patients using frequency matched stimulation had an improvement of about 0.8 to about 0.9 points in BF-ADL scoring, with an n=46 and p=0.038. Under phase reset stimulation, patients had an improvement of about 1 to about 1.2 in BF-ADL scoring, with n=47 and p=0.026. With inactive stimulation, patients had an improvement of about 0.30 to about 0.4 in BF-ADL scoring with n=47 and p=0.251. The P value between frequency matched and inactive stimulation was about 0.132. The P value between phase reset and inactive stimulation was about 0.047.

For cumulative improvement, stimulation was provided over about 3 days to about 5 days. Patients using frequency matched stimulation had an improvement of about 1.2 to about 1.5 in BF-ADL scoring with n=45 and p=0.010. Patients under phase reset stimulation had an improvement of about 1.6 to about 1.9 in BF-ADL scoring with n=44 and p=<0.001. Patients with inactive stimulation had an improvement of about 0.30 to about 0.5 in BF-ADL scoring with n=46 and p=0.182. A P value between frequency matched and inactive patients was about 0.042, and a P value between phase reset and inactive patients was about <0.001.

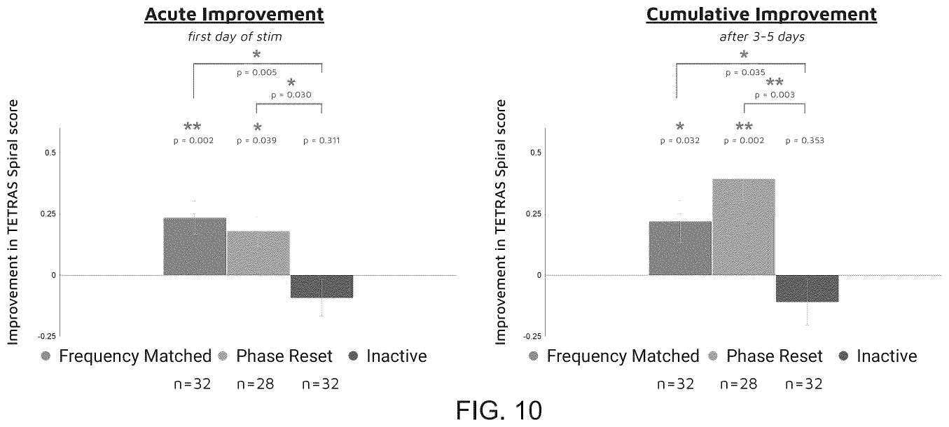

FIG. 10 illustrates test results of acute improvement and cumulative improvement using TETRAS Spiral scores is presented. For acute improvement, patients had an improvement of about 0.25 in TETRAS Spiral scoring under frequency matched stimulation, with n=32 and p=0.002. Patients had an improvement of about 0.22 to about 0.25 in TETRAS Spiral Scoring under phase reset stimulation with n=28 and p=0.039. Patients had an improvement by about −0.10 in TETRAS Spiral Scoring under inactive stimulation with n=32 and p=0.311. The P value between frequency matched and inactive patients was about 0.005 and the P value between phase reset and inactive patients was about 0.030. For cumulative improvement over the course of about 3 to 5 days, patients had an improvement by about 0.25 in TETRAS spiral scoring under frequency matched stimulation with n=32 and p=0.032. Patients had an improvement of about 0.4 in TETRAS Spiral scoring under phase reset stimulation with n=28 and p=0.002. Patients had an improvement by about −0.15 in TETRAS Spiral scoring under inactive stimulation with n=32 and p=0.353. The P value between frequency matched and inactive stimulation was about 0.035 and the P value between phase reset and inactive stimulation was about 0.003.

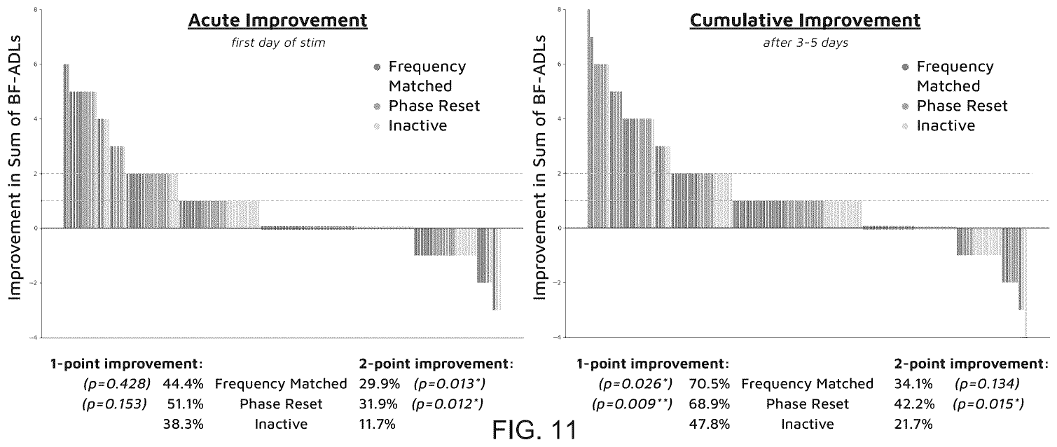

FIG. 11 illustrates a total BF-ADL score responder analysis between acute improvement and cumulative improvement. Therapeutic gain (TG) was measured by subtracting each subject's improvement under sham stimulation from an improvement under actual stimulation. A best stim pattern per subject was calculated by comparing a best improvement between the frequency matched and phase reset stimulation patterns.

For acute improvement (first day of stimulation), about 44.4% of subjects with a p value of 0.428 had a 1 point improvement in a sum of BF-ADLS scoring under frequency matched stimulation while about 29.9% of subjects with a p value of 0.013 had a 2 point improvement under frequency matched stimulation. About 51.1% of subjects with a p value of 0.153 had a 1 point improvement with a phase reset stimulation while about 31.9% with a p value of 0.012 had a 2 point improvement. 38.3% of subjects with inactive stimulation showed a 1 point improvement while 11.7% of subjects with inactive stimulation showed a 2 point improvement.

For cumulative improvement (after about 3-5 days), about 70.5% of subjects with a p value of 0.026 given frequency matched stimulation showed a 1-point improvement while about 34.1% of subjects with a p value of 0.134 given frequency matched stimulation showed a 2-point improvement. About 68.9% of subjects with a p value of 0.009 given a phase reset stimulation showed a 1 point improvement while about 42.2% of subjects with a p value of 0.015 given a phase reset stimulation showed about a 2 point improvement. 47.8% of patients given an inactive stimulation showed a 1 point improvement and 21.7% of subjects given an inactive stimulation showed about a 2 point improvement.

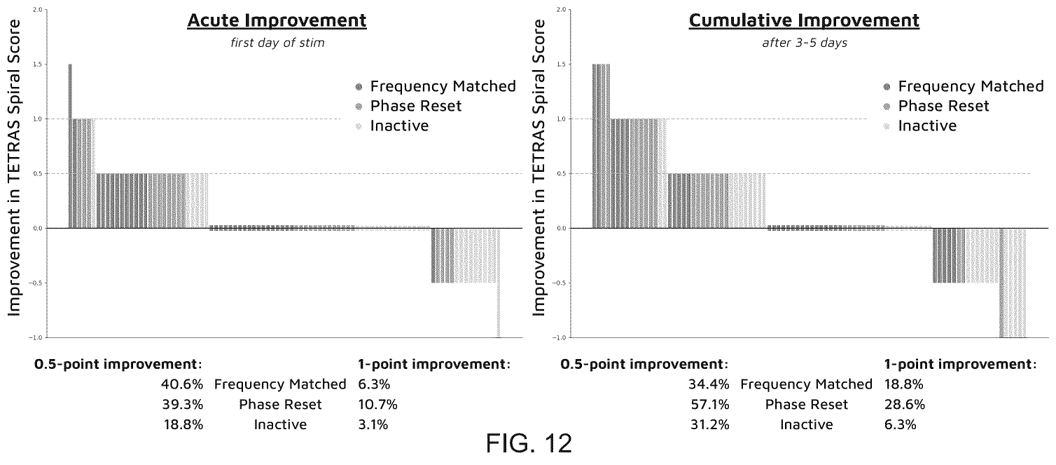

FIG. 12 illustrates a TETRAS spiral responder analysis of both acute and cumulative (about 3-5 days) improvements of subjects. For acute improvement, 40.6% of subjects given a frequency matched stimulation had a 0.5 point improvement in the TETRAS spiral score while 6.3% had 1 point improvement. 39.3% of subjects given a phase reset stimulation had a 0.5 point improvement and 10.7% of patients given a phase reset stimulation had a 1 point improvement. 18.8% of subjects given no stimulation had a 0.5 point improvement and 3.1% of subjects given no stimulation had a 1 point improvement.

For cumulative improvement, about 34.4% of subjects given a frequency matched stimulation had a 0.5 point improvement and about 18.85 given frequency matched stimulation had about a 1 point improvement. About 57.1% of subjects given a phase reset stimulation had a 0.5 point improvement and about 28.6% of subjects given a phase rest stimulation had a 1 point improvement. About 31.2% of subjects given no stimulation had a 0.5 point improvement and about 6.3% of subjects given no stimulation had a 1 point improvement.

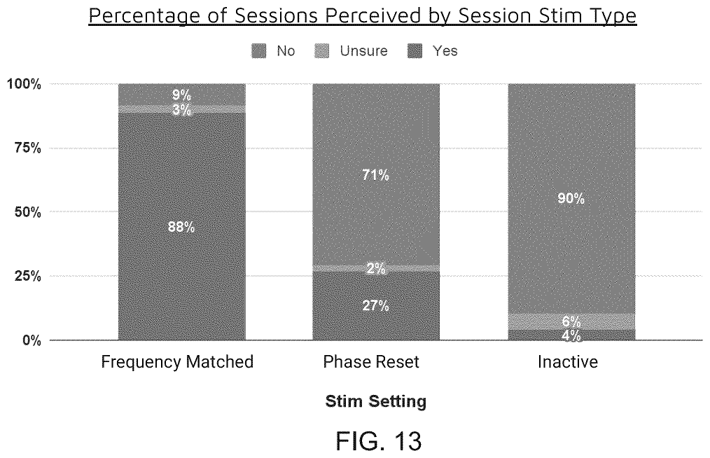

FIG. 13 illustrates a perception of stimulation in patients. About 88% of subjects given a frequency matched stimulation reported feeling stimulation, while 3% were unsure and 9% reported not perceiving stimulation. About 27% of subjects given a phase reset stimulation reported feeling stimulation while about 2% were unsure and about 71% reported not perceiving stimulation. About 90% of subjects given no stimulation reported not feeling stimulation, about 6% reported unsure, and about 4% reported feeling stimulation. As shown, less than about 30% of phase reset stimulation sessions were reported as perceived.

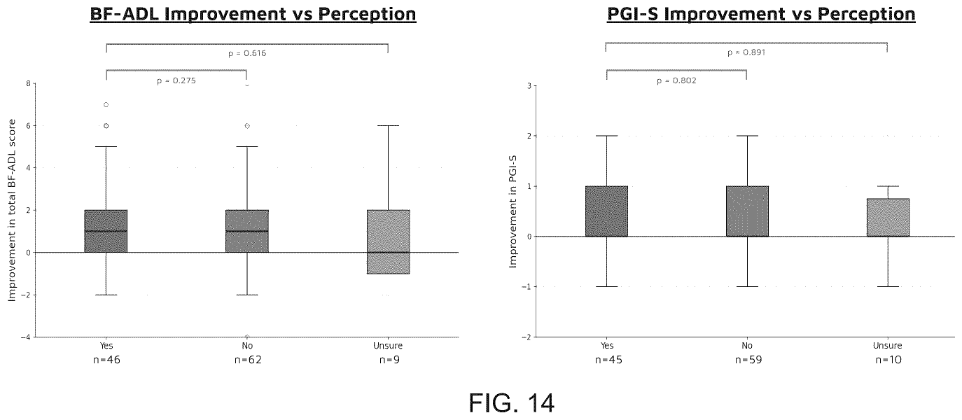

FIG. 14 illustrates a comparison of perception of stimulation versus improvements in movement disorder symptoms. Patients that reported “yes” to perceiving stimulation had an improvement in total BF-ADL scores by about 1 to about 2 (n=46), while patients that responded “no” to perceiving stimulation had an improvement in total BF-ADL scoring by about 1 to about 2 (n=62). The P value between those patients that reported “yes” and patients that reported “no” was about 0.275. Patients that responded “unsure” had a range of about −1 to about 2 in improvement in total BF-ADL Scoring, with n−9. The P value between those that reported “yes” and those that reported “unsure” was about 0.616.

Improvements were also measured by Patient Global Impression of Severity (PGI-S) scores. Patients that reported “yes” to perceiving stimulation had an improvement in PGI-S scores of about 1 to 2, with n=45. Patients that reported “no” to perceiving stimulation had an improvement in PGI-S scores of about 1 to about 2 with n=59. Patients that reported “unsure” had an improvement in PGI-S scores of about 1 to about 1.8 with n=10. The P value between patients that reported “yes” and patients that reported “no” was about 0.802, while the P value between patients that reported “yes” and patients that reported “unsure” was about 0.891.

### Methods

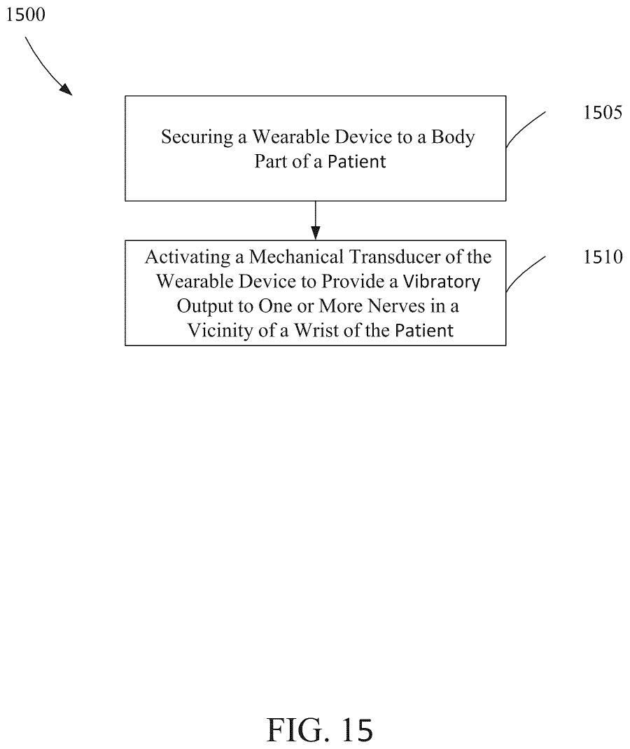

Referring now to FIG. 15, a method 1500 of reducing movement disorder symptom severity in a patient is presented. At step 1505, method 1500 includes securing a wearable device to a body part of a patient. A wearable device may be secured using a wristband or other device. A wearable device may include one or more processors, sensors, transducers, wireless communication devices, or other components. In some embodiments, a wearable device may include one or more transducers embedded within a wrist strap. A wrist strap may be secured to a wrist of a patient, which may cause one or more transducers to come into contact with a patient's wrist. This step may be implemented as described above with reference to FIGS. 1-6, without limitation.

At step 1520, method 1500 includes activating a mechanical transducer of the wearable device to provide a vibratory output to one or more nerves in a vicinity of a wrist of the patient. A mechanical transducer may include a vibratory motor, in some embodiments. A patient may activate the mechanical transducer through one or more interactive elements of the wearable device. In some embodiments, a processor of the wearable device may automatically active the transducer based on sensor data of one or more sensors of the wearable device.

The vibratory output may have a vibrational strength of about 0.30 Gᵣₘₛ to about 0.78 Gᵣₘₛ. In some embodiments, a vibrational strength of the vibratory output may be below a subsensory threshold of the patient. The vibratory output may have a frequency of about 4 Hz to about 6 Hz. In some embodiments, the vibratory output may have a frequency of about ⅛ Hz to about ¼ Hz. In some embodiments, the vibratory output may be a continuous single pulse. The vibratory output may be calculated as a subharmonic of a frequency of a movement disorder symptom of a patient. For instance, a subharmonic may be calculated as about 1/48^{th}, or about ⅛^{th} to ¼^{th} of a frequency of a movement disorder symptom of a patient, such as a tremor frequency. In some embodiments, the one or more nerves may be proprioceptive nerves. The vibratory output may be provided to a C8 dermatome of the patient. This step may be implemented as described above, without limitation, with reference to FIGS. 1-14.

Method 1500 may include providing an auxiliary output to the patient. An auxiliary output may be provided in combination with or alternatively to the vibratory output. An auxiliary output may have a higher vibrational strength, such as about or greater than about 0.8 Gᵣₘₛ. An auxiliary output may have a higher frequency than the vibratory output. In some embodiments, an auxiliary output may be frequency matched to one or more frequencies of a movement disorder symptom of the patient, such has a tremor. An auxiliary output may automatically be generated based on sensor data provided to a processor of the wearable device. For instance, a processor may be configured to detect an increase in amplitude, frequency, or other parameters of a symptom of a movement disorder, such as a tremor. In response to a detected increase in movement disorder symptoms, a processor of the wearable device may activate one or more mechanical transducers to output an auxiliary output. In some embodiments, a patient may select an auxiliary output to be provided through one or more patient interface elements of the wearable device.

What is claimed is:

1. A method of reducing movement disorder symptom severity of a patient, comprising:
securing a wearable device to a body part of the patient through an attachment system; and
activating a mechanical transducer of the wearable device to provide a vibratory output to one or more nerves in a vicinity of a wrist of the patient, wherein the vibratory output has a vibrational strength of about 0.30 Gᵣₘₛ to about 0.78 Gᵣₘₛ.

2. The method of claim 1, wherein the vibrational strength is below a sensory threshold of the patient.

3. The method of claim 1, wherein the vibratory output has a frequency of about 0.1 Hz to about 6 Hz.

4. The method of claim 1, wherein the vibratory output is a repeatable single pulse.

5. The method of claim 1, further comprising calculating the vibratory output as a subharmonic of a frequency of a movement disorder symptom of the patient.

6. The method of claim 5, wherein the subharmonic is between 1/30^{th} and 1/120^{th} of the frequency of the movement disorder symptom of the patient.

7. The method of claim 1, further comprising activating an auxiliary vibratory output of the wearable device, wherein the auxiliary vibratory output of the wearable device has a vibrational strength greater than about 0.8 Gᵣₘₛ.

8. The method of claim 7, wherein the auxiliary vibratory output is frequency matched to a frequency of a movement disorder symptom of the patient.

9. The method of claim 1, wherein the one or more nerves are proprioceptive nerves.

10. The method of claim 1, wherein vibratory output is provided to a C8 dermatome of the patient.

11. A wearable device for mitigating movement disorder symptoms, comprising:
an attachment system configured to secure the wearable device to a body part of a patient;
a single mechanical transducer; and
a processor in communication with the single mechanical transducer, the processor configured to activate the single mechanical transducer to provide a vibratory output to one or more nerves in a vicinity of a wrist of the patient, wherein the vibratory output has a vibrational strength of about 0.30 Gᵣₘₛ to about 0.78 Gᵣₘₛ.

12. The wearable device of claim 11, wherein the vibrational strength is below a sensory threshold of the patient.

13. The wearable device of claim 11, wherein the vibratory output has a frequency of about 0.1 Hz to about 6 Hz.

14. The wearable device of claim 11, wherein the vibratory output is a repeatable single pulse.

15. The wearable device of claim 11, wherein the processor is further configured to calculate the vibratory output as a subharmonic of a frequency of a movement disorder symptom of the patient.

16. The wearable device of claim 15, wherein the subharmonic is between 1/30^{th} and 1/120^{th} of the frequency of the movement disorder symptom of the patient.

17. The wearable device of claim 11, wherein the processor is further configured to provide an auxiliary vibratory output through the mechanical transducer, wherein the auxiliary vibratory output of the wearable device has a vibrational strength greater than about 0.8 Gᵣₘₛ.

18. The wearable device of claim 17 wherein the auxiliary vibratory output is frequency matched to a frequency of a movement disorder symptom of the patient.

19. The wearable device of claim 11, wherein the wherein the one or more nerves are proprioceptive nerves.

20. The wearable device of claim 11, wherein vibratory output is provided to at least a C8 dermatome of the patient.
